(19) United States
(12) Patent Application Publication
(10) Pub. No.: US 2002/0095361 A1
(43) Pub. Date: Jul. 18, 2002

(54) Method and system for securitizing a future obligation to purchase goods or services

(76) Inventors: Michael Trenk, Scarsdale, NY (US); Judah E. Kaplan, Teaneck, NJ (US); Steven Cohen, Brooklyn, NY (US); James E. Lewis, New York, NY (US); Fred Slavin, Manalapan, NJ (US); Stephan V. Donelian, New York, NY (US)

Correspondence Address: OSTROLENK FABER GERB & SOFFEN, 1180 AVENUE OF THE AMERICAS, NEW YORK, NY, 100368403

(21) Appl. No.: 09/760,576

(22) Filed: Jan. 16, 2001

(51) Int. Cl. G06F 17/60

(52) U.S. Cl. 705/35

(57) ABSTRACT

A company with underperforming assets sells these assets to a trading house in exchange for value and a promise to make future purchases from the trading house. The value is provided by a financial institution. A portion of the money received by the trading house from the future purchases is given to the financial institution to pay back the value plus interest. To securitize the promise to make future purchases, the financial institution creates a special purpose entity which, in turn, creates a trust. Investors provide money to the special purpose entity which is used to purchase low risk assets that are placed in the trust. The special purpose entity then makes an agreement with the financial institution that if the company with underperforming assets defaults on its promise to purchase, the financial institution can take money from the trust. In exchange, the financial institution agrees to give the special purpose entity, and thus the investors, a large portion of the interest it receives as a result of future purchases made by the company with underperforming assets.

### BACKGROUND OF THE INVENTION

1. Field of the Invention

The invention relates generally to a securitizing method, in particular, to a method for securitizing a company's future obligations to purchase goods and/or services.

2. Description of the Related Art

In the manufacturing and service sectors, many companies have assets which are out of fashion, obsolete, time sensitive, close to their usage or expiration date, and whose value in liquidation would be significantly below cost or book value. Examples of these underperforming assets (hereinafter “UPAs”) include apparel, machinery, computers, pharmaceuticals, furniture, film, etc. If an asset is overproduced or shows early signs of under-performance, financial accounting rules discourage companies from selling or otherwise disposing of the asset. If a company with UPAs (hereinafter a “UPA company”) were to make a pre-emptive sale, or markdown the UPAs below book value, this would result in an immediate loss.

Conventionally, corporate trading houses provide a solution for UPA companies to avoid this loss. Referring to FIG. 1, corporate trading houses 14 have access to foreign and domestic markets and forge business relationships with potential buyers 16 of underperforming assets (hereinafter “UPA buyer”). Trading houses 14 also receive discounts from various suppliers 18 of goods and services which trading house 14 can pass on to a UPA company 12. For example, trading house 14 may obtain airline tickets from a major airline (supplier 18) at a significant discount because trading house 14 can guarantee the airline a minimum number of purchases over a given period of time.

In operation, trading house 14 accepts UPAs 13 from UPA company 12 in exchange for some value 11 greater than the liquidation value of UPAs 13. In some instances, trading house 14 will provide UPA company 12 with the full value of UPAs 13. In addition to providing trading house 14 with UPAs 13, UPA company 12 provides a promise 15 to purchase goods and/or services from trading house 14 within an agreed upon period of time. This transaction between trading house 14 and UPA company 12 will hereinafter be referred to as a “UPA transaction”. Trading house 14 then uses its position in a UPA buyers market to sell UPAs 13 to UPA buyers 16. During the agreed upon period of time, UPA company 12 then purchases goods and/or services 19 (hereinafter collectively referred to as “goods”) from trading house 14 (e.g., discounted airline tickets procured from supplier 18) to satisfy its promise 15.

In UPA transactions as described above, a three-way agreement is actually used. In this agreement, UPA company 12 sells its UPAs 13 to trading house 14 typically in return for a cash payment 11 that is frequently provided by a financial institution 10. Money flows from financial institution 10 either directly to UPA company 12 or indirectly through trading house 14. In some cases, UPA company 12 may elect to receive other assets, for example goods from another supplier (not shown), in exchange for its UPAs. In that case, financial institution 10 provides payment directly to such supplier of such goods.

The three way agreement also includes a provision where UPA company 12 provides a promise 15 in that it incurs a future consumption obligation (“FCO”) to make future purchases of goods or services from trading house 14. The future consumption obligations 15 represent the amount of value 11 given to UPA company 12 by financial institution 10 in excess of the present value of UPAs 13, plus some interest which accrues during the life of promise/FCO 15. Each time UPA company 12 makes a purchase of goods or services from trading house 14, a percentage of the sale is given to financial institution 10 and represents repayment of value 11. For example, if UPA company 12 buys $1,000,000 in airline tickets, $100,000 may be forwarded to financial institution 10. This repayment is actually payment of the principal 17 of value 11 plus some interest 9. This process continues until UPA company 12 has satisfied its future consumption obligations 15 according to the terms of the UPA transaction. At that point, financial institution 10 will have been fully repaid with interest. The interest itself can be quite large—sometimes in a magnitude of as much as four to six percent over the UPA company's 12 regular borrowing cost. Such a UPA transaction is shown and described in copending application serial number XX/XXX,XXX for CORPORATE PRODUCTS TRADING MARKETPLACE filed on the same date (attorney docket number P/2167-248); the entirety of this application is hereby incorporated by reference.

Frequently, as is shown in FIG. 2, financial institution 10 will provide value for a plurality of UPA companies 12a, 12b, 12c. These UPA companies 12a, 12b, 12c thereby incur corresponding future consumption obligations (“FCOs”) 15a, 15b, 15c to buy goods/services from trading house 14 that will inevitably pay back financial institution 10 with principal 17a, 17b, 17c plus interest 9a, 9b, 9c.

The UPA transaction described above has some undesirable features to financial institution 10 because, financial institution 10 incurs a risk that UPA company 12 will default on its promise 15 to purchase goods and/or services from trading house 14. In such a default, financial institution 10 will not receive principal 17 and interest 9. Clearly, in the event of default by UPA company 12, financial institution 10 can take legal action to recover any amounts owed on the three way contract referenced above; but only as an unsecured creditor. Financial institution 10 receives a large return on its initial investment, however, financial institutions in general do not like to have a large amount of risk outstanding. As such, these financial institutions 10 desire a way of transferring or avoiding this risk.

One prior art method for transferring risk is through securitization. In such an arrangement, risk assets due to a financial institution such as residential or commercial mortgages, credit card receivables, equipment leasing or even student loans, are pooled together and used to back notes which are sold to investors. The investment capital raised by selling the notes is placed in a trust where it earns interest. Should a debtor (e.g. the commercial mortgagor) default, the financial institution can still recover principal from the trust. However, such securitization techniques are based upon assets or promises owed to the financial institution itself. In a UPA transaction described above, UPA companies have a promise to purchase goods or services from a third party—the trading house. Prior art securitization techniques do not protect such an arrangement.

Moreover, prior art securiziation techniques do not have the ability to evaluate the apparent credit risk of a UPA company 12 performing its obligation. Prior art obligations are secured based on the possibility of an obligor failing to meet a debt obligation. Such techniques do not relate to underwriting an ability of an obligor to purchase future goods or services. Further, trading houses 14 have a finite number of products and there is the possibility that the UPA company 12 will no longer need products which are available from the trading house 14. For example, prior art methods for securitization can analyze the credit risk (i.e., ability to repay debt) of a company. However, that same credit risk analysis may not apply when evaluating whether the company has the ability to meet its obligations to make future purchases. The analysis required to determine whether a company can meet obligations to make future purchases may factor certain elements into the analysis, such as the need for a certain good or service (e.g., advertising time), where those same elements may not be relevant to a determination of whether the company will be able to meet obligations associated with debt (i.e., repayment of a loan).

Thus, there exists a need in the art for a method and system for securitizing cash flow wherein the cash flow is derived from a future obligation to purchase goods or services.

### SUMMARY OF THE INVENTION

A company with underperforming assets sells these assets to a trading house in exchange for value and makes a promise of future purchases from the trading house. The value is provided by a financial institution. A portion of the money received by the trading house from the future purchases is given to the financial institution to pay back the value plus interest. To securitize the promise to make future purchases, the financial institution creates a special purpose entity which, in turn, creates a trust. Investors provide money to the special purpose entity which is used to purchase low risk assets that are placed in the trust. The special purpose entity then makes an agreement with the financial institution that if the company with underperforming assets fails to make future purchases, the financial institution can take money from the trust. In exchange, the financial institution agrees to give the special purpose entity, and thus the investors, a large portion of the interest it receives as a result of future purchases made by the company with underperforming assets.

### BRIEF DESCRIPTION OF THE DRAWINGS

For the purpose of illustrating the invention, there is shown in the drawings a form which is presently preferred, it being understood, however that the invention is not limited to the precise arrangements and instrumentality shown.

FIG. 1 is a diagram illustrating the relationships and interactions among parties in an underperforming asset transaction of the prior art.

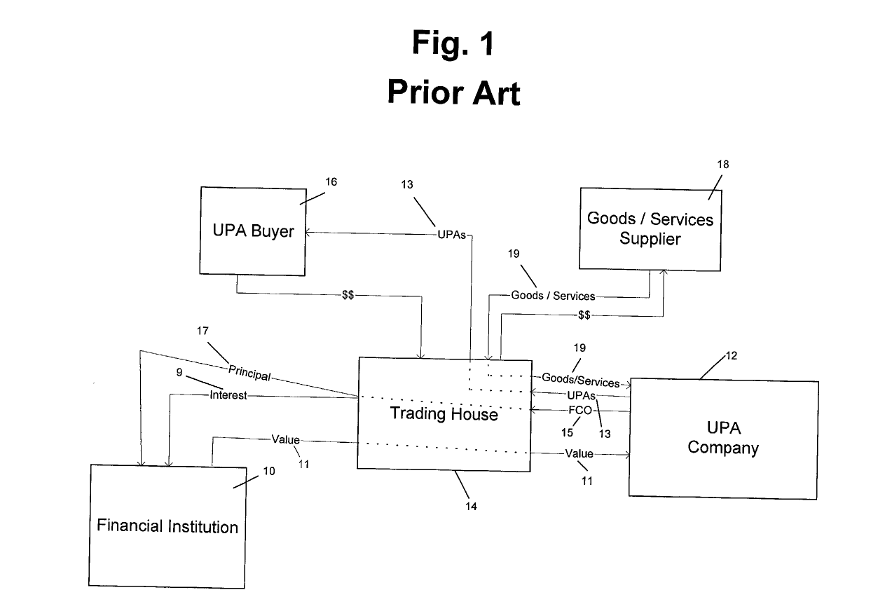

FIG. 2 is a diagram illustrating an example of multiple UPA companies involved in UPA transactions with a trading house and a financial institution in accordance with the prior art.

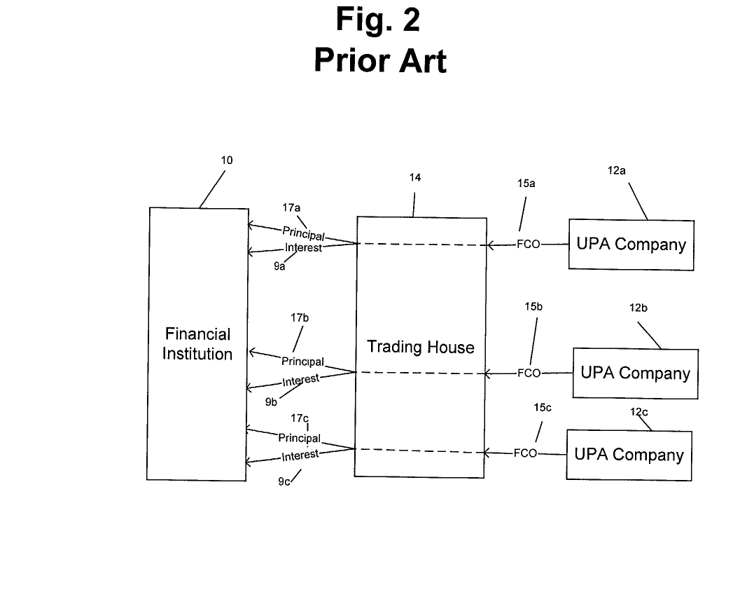

FIG. 3 is a diagram illustrating a securitization system in accordance with the invention.

FIG. 4 is a diagram illustrating another embodiment of a securitization system in accordance with the invention.

### DETAILED DESCRIPTION OF THE INVENTION

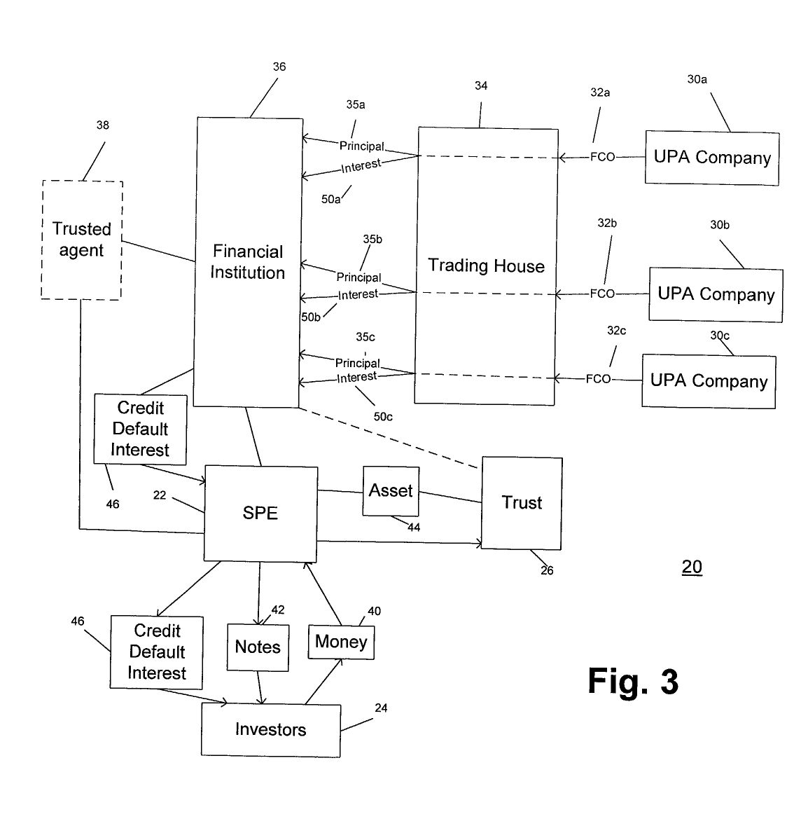

Referring to FIG. 3, there is shown a securitization system 20 in accordance with the present invention. As in the prior art, a UPA transaction is arranged so that financial institution 36 gives UPA companies 30a, 30b, 30c some value in exchange for UPA companies 30a, 30b, 30c giving their respective UPAs (not shown) to a trading house 34 and incurring FCOs 32a, 32b and 32c to trading house 34. It should be noted that although a UPA company is shown and described, the invention applies to any company which incurs an obligation to make purchases with another party where a portion of the money paid for those purchases is given to a third party. In fact, the value given to the labeled UPA company may not even relate to UPAs at all. It could, for example, be merely a cash conveyance.

FCOs 32a, 32b, 32c, when fulfilled, provide financial institution 36 the principal 35a, 35b, 35c of the value given to UPA company 30a, 30b, 30c along with interest 50a, 50b, 50c. However, unlike the prior art, the invention allows financial institution 36 to transfer its risk resulting from the UPA transactions by selling the risk to investors in the form of a type of securitization.

To transfer this risk, financial institution 36 creates a special purpose entity (“SPE”) 22 to handle the securitization. Alternatively, a trusted agent 38 may be employed by financial institution 36 to originate SPE 22. SPE 22 is a company or partnership that either acts as a trustee or causes a trust 26 to be created. SPE 22 may be created for the limited purpose of originating and controlling trust 26. Trust 26 is used to transfer the risk that one of the UPA companies 30a, 30b, 30c will default on its future consumption obligations 32a, 32b, 32c with trading house 34.

Once trust 26 is created, SPE 22 then invites investors 24 to provide money 40 in exchange for notes 42 (promises to pay back the money), from SPE 22. SPE 22 thus does not have any assets except trust 26 which will be attached in the event of a default or other credit event. The money 40 raised from investors 24 through the issuance of notes 42 is used to purchase a low risk asset 44, for example government bonds. Asset 44 is placed in trust 26 and controlled by SPE 22.

SPE 22 then enters into an agreement with financial institution 36, where SPE 22 guarantees financial institution 36 repayment of future consumption obligations 32a, 32b, 32c if a UPA company 30a, 30b, or 30c defaults or a credit event (as defined below) occurs. In exchange, financial institution 36 agrees to give a fixed payment, which (in the preferred embodiment) may be a portion of interest 50a, 50b, 50c that it would have otherwise earned in the UPA transactions, to SPE 22. This arrangement between SPE 22 and financial institution 36 is similar to a credit default swap. SPE 22 agrees to accept the risk of a default by UPA companies 30a, 30b, 30c in exchange for some value-part of interest 50a, 50b, 50c that financial institution 36 would have received if UPA companies 30a, 30b, 30c did not default. Financial institution 36 still receives all of the principal 35a realized through fulfillment of FCO 32a. Investors 24 are forewarned about this intended contract and send money 40 to SPE 22 with this knowledge. In an alternative embodiment, investors 24 contract with financial institution 36 without the conduit of SPE 22.

In the preferred embodiment, financial institution 36 retains a small portion of the interest 50a, 50b, 50c earned when FCOs 32a, 32b, 32c are fulfilled. One component of interest payments 50a, 50b, 50c in UPA transactions is basis points, where one basis point is equal to 1/100 percent of the principal amount owed. For example, if financial institution 36 gives UPA company 30a value totaling $1,000.00, one basis point would be $0.10. In the credit default swap of the invention, financial institution 36 may agree to give all interest payments to SPE 22 except the basis points.

As an illustrative example, after forming a UPA transaction, among UPA company 30a,trading house 34, and financial institution 36, UPA company 30a makes purchases from trading house 34 of goods and/or services to fulfill FCO 32a. Trading house 34 then forwards financial institution 36 principal 35a and interest 50a as defined by the terms of the UPA transaction based on the amount of purchases by UPA company 30a (e.g., $1,000,000 in purchases results in $100,000 going to financial institution 36). In accordance with the invention, financial institution 36 then gives a portion of interest 50a to SPE 22 in the form of a credit default interest 46. SPE 22 then forwards credit default interest 46 to investors 24. This arrangement is effectively a credit default swap between financial institution 36 and investors 24.

SPE 22 continues to receive credit default interest 46 but makes no payments to financial institution 36 except if there is a credit event. A credit event occurs when some economic condition regarding companies 30a, 30b, 30c changes. Examples of credit events include bankruptcy, debt restructuring, cross-acceleration of a loan and a material failure to fulfill a FCO. A material economic change in the UPA companies themselves can also trigger a credit event. If a credit event occurs with, for example, UPA company 30a,financial institution 36 is entitled to receive from SPE 22 the balance outstanding of principal 35a and interest 50a that financial institution 36 would have received as a result of FCO 32a. That balance is paid from trust 26. Note that the credit event may be totally unrelated to FCO 32a. For example, if UPA company 30a defaults on an unrelated loan, a credit event has occurred. Again, investors 24 are forewarned about the consequences of a credit event.

If a credit event occurs and financial institution 36 attaches the corpus of trust 26 to receive payment of principal 35a and interest 50a, investors 24 are at risk that full returns on their investments will not be realized. If UPA company 30a is completely unable to satisfy its future consumption obligations 32a, however, investors 24 have a legal cause of action against UPA company 30a to recover the amount of principal 35a withdrawn by financial institution 36 from trust 26. The risk of companies 30a, 30b, 30c defaulting on FCOs 32a, 32b, 32c is thus transferred from financial institution 36 to investors 24.

In exchange for this protection, investors 24 receive regular payments from financial institution 36 of credit default interest 46 representing returns on their investments. Payments to investors 24 may be structured in different ways, including, for example, several times a year, or once annually. As future consumption obligations 32a-c are satisfied, a corresponding percentage of trust 26 is no longer needed to securitize the risk that financial institution 36 will not receive principal 35a, 35b, 35c. Investors 24 may choose to realize this portion of trust 26 (including accumulated interest). Some investors 24 may elect to forego all payments and keep their balance of principal and interest in trust 26 or reinvest credit default interest 46 in asset 44. Therefore, the corpus of trust 26 may fluctuate in size according to the rate that future consumption obligations are satisfied and returns are paid to investors 24.

By way of example, assume that financial institution 36 gives $1,000,000 to UPA company 30a in exchange for a promise to purchase 32a $5,800,000 worth of goods and/or services in the future from trading house 34. If financial institution 36 receives $1 for every $5 expended on the purchases, financial institution 36 will eventually receive $1,160,000 (5,800,000/5) in return.

Further in this example, investor 24 invests $1,000,000 with SPE 22 and the investment is used initially to purchase low risk assets 44, for example treasury bills, returning roughly 5% or $50,000. In addition to the return on the treasury bills, interest 50a accrued as a result of purchases by UPA company 30a minus fees retained by financial institution 36 (e.g., basis points), are placed into the trust 26. For simplicity, assume that interest 50a minus basis points is assessed at 6%. Thus, on a $1,000,000 investment, the expected return which will flow to SPE 22 is $60,000. Once credit default interest 46 flows to SPE 22, it may be further invested in low risk assets 44, earning an additional 5% or up to $3,000 (depending on when UPA company 30a satisfies FCO 32a). In a preferred embodiment, UPA company 30a will be given an incentive to pay back FCO 32a as early as possible. The total return on investor 24's $1,000,000 investment therefore equals $50,000 (return from treasury bills), plus $60,000 (credit default interest 46 payments) plus up to $3,000 (return from treasury bills 44 purchased the credit default interest payments) totaling $113,000 or 11.3% of the original investment. This is a significantly better investment return than, for example, typical corporate bonds which return roughly 9% on investments.

Financial institution 36 disposes of the risk that UPA companies 30a, 30b, 30c will default on their future consumption obligations 32a, 32b, 32c and hedges the risk that UPA companies 30a, 30b, 30c will satisfy their future consumption obligations and pay valuable interest. In other words, financial institution 36 is hedging the risk that UPA companies 30a, 30b, 30c will default, with the risk of losing profitable interest.

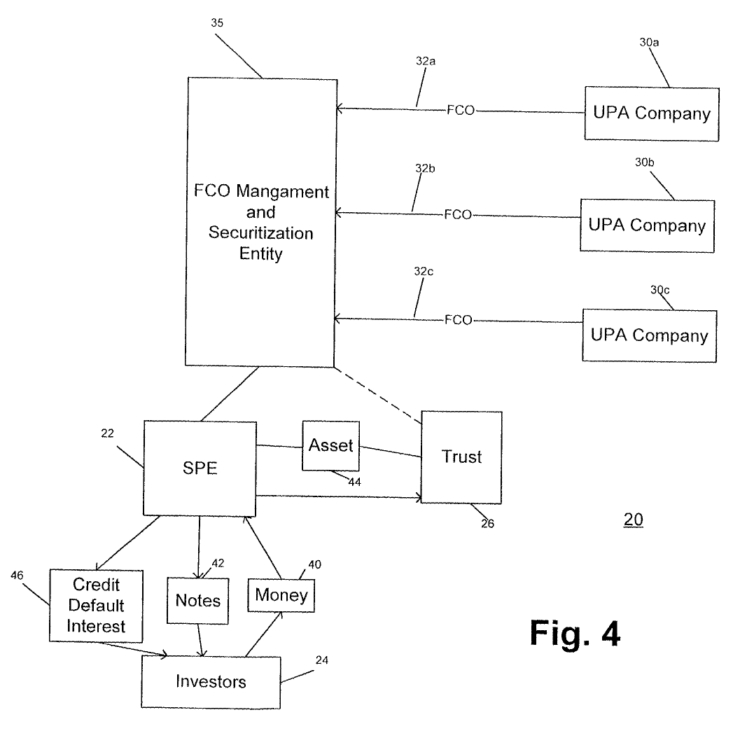

Referring now to FIG. 4, there is shown an alternative embodiment of the invention. FCO Management and Securitization Entity 35 provides UPA Company 30a with value in exchange for UPAs and UPA company's future consumption obligations 32a as noted above. As UPA company 30a makes future purchases, thereby satisfying future consumption obligations 32a, FCO Management and Securitization Entity 35 receives a percentage from each sale. This can occur in different ways. For example, money can flow through FCO Management and Securitization Entity 35 whereby FCO Management and Securitization Entity 35 retains a percentage of each sale. Alternatively, a portion of each future sale is distributed to FCO Management and Securitization Entity 35 after the sale has been completed.

FCO Management and Securitization Entity 35 may then transfer its risk resulting from FCOs 32a in the form of the securitization technique discussed above using SPE 22 and trust 26.

Investors 24 are likely to be persuaded to invest in securitization system 20 for the following reasons. First, the credit risks of UPA companies 30a-c in UPA transactions are measured prior to the UPA transactions themselves. In fact, UPA company 30a-c may be unable to enter into a UPA transaction with trading house 34 and financial institution 36 if its credit rating is questionable. Additionally, the interest rate reflected in the amount of purchases that the UPA company 30a-c will have to make to fulfill its FCO 32a-c, may be prohibitive and so a UPA company 30a-c with a poor credit history may be unable to enter into the UPA transaction. In any case, investors 24 will assess whether the risk undertaken by the financial institution 36 is too great for an investment to be made with SPE 22.

Second, investors will presumably realize that UPA companies 30a-c with future consumption obligations 32a-c have much to gain by satisfying their obligations. UPA companies 30a-c are typically guaranteed that the prices for goods and/or services which they will purchase from trading house 34 will be competitive. Since UPA companies 30a-30c will presumably purchase the same goods and/or services notwithstanding the UPA transaction, the likelihood is high that these UPA companies 30a-c will not default.

Third, large UPA companies 30a-c have good reputations which are likely to induce confidence in investors 24. For example, large companies like LIZ CLAIBORNE and HEWLETT PACKARD have sold underperforming assets in the form of apparel and computers respectively, and the likelihood of a credit event occurring with these companies is relatively small. The reputation of the UPA companies 30a-c may be sufficient to instill confidence in the investment market that future consumption obligations 32a-c will be satisfied. Further, investors 24 have the option of investing in FCOs 32a-c owed by specific companies or diversifying their risk over FCOs from a plurality of companies.

Fourth, the return on the investments described above is attractive and yields significantly higher rates than other investments such as corporate bonds. Presumably, investors will assess the percentage of risk with the return on their investments and conclude that the low likelihood of a credit event is an acceptable risk. The returns on the investments will serve to make the risks to investors palatable.

Thus, by creating a contract between the trustee of a funded trust and a financial institution expecting principal and interest from future consumption obligations, a future obligation to purchase can be securitized.

The present invention may be embodied in other specific forms without departing from the spirit or essential aspects thereof and, accordingly, reference should be made to the appended claims, rather than to the foregoing specification, as indicating the scope of the invention.

What is claimed is:

1. A method for securitizing an obligation to purchase goods/services, the method comprising:
obligating a first party with a first obligation to purchase goods/services from a second party using first money;
obligating the second party with a second obligation to give a third party a portion of the first money received from the first party;
creating a trust;
receiving second money from investors;
funding the trust with the second money;
obligating the third party with a third obligation to give the trust a portion of the first money received from the second party; and
allowing the third party to take from the trust if the first party experiences a credit event.

2. The method as recited in claim 1, wherein the credit event includes a default on the first obligation.

3. The method as recited in claim 1, wherein the trust is controlled by a fourth party created by the third party.

4. The method as recited in claim 1, wherein the trust is controlled by a fourth party created by a fifth party.

5. The method as recited in claim 1, further comprising giving the investors notes in exchange for the second money.

6. The method as recited in claim 1, further comprising:
obligating the first party to sell underperforming assets to the second party; and
obligating the second party to give the first party value in exchange for the underperforming assets.

7. The method as claimed in claim 6, wherein the value is provided by the third party.

8. The method as recited in claim 1, wherein the funding includes purchasing a low risk asset.

9. A contractual arrangement for securitizing an obligation to purchase goods/services, the arrangement comprising:
a first obligation where a first party is obligated to purchase goods/services from a second party using first money;
a second obligation where a second party has a second obligation to give a third party a portion of the first money received from the first party;
investors who provide second money;
a trust funded with the second money;
a third obligation where the third party agrees to give the trust a portion of the first money received from the second party, and
a fourth obligation where the investors agree to allow the third party to take from the trust if the first party experiences a credit event.

10. The arrangement as claimed in claim 9, wherein the credit event includes a default on the first obligation.

11. The arrangement as recited in claim 9, wherein the trust is controlled by a fourth party created by the third party.

12. The arrangement as recited in claim 9, wherein the trust is controlled by a fourth party created by a fifth party.

13. The arrangement as recited in claim 9, wherein the investors receive notes in exchange for the second money.

14. The arrangement as recited in claim 11, wherein the investors receive notes from the fourth party in exchange for the second money.

15. The arrangement as recited in claim 12, wherein the investors receive notes from the fourth party in exchange for the second money.

16. The arrangement as recited in claim 9, further comprising:
an obligation by the first party to sell underperforming assets to the second party; and
an obligation by the second party to give the first party value in exchange for the underperforming assets.

17. The arrangement as claimed in claim 16, wherein the value is provided by the third party.

18. The arrangement as recited in claim 9, wherein the trust is funded with a low risk asset purchased with the second money.

19. A method for securitizing an obligation to purchase goods/services, the method comprising:
obligating a first party with a first obligation to purchase goods/services from a second party using first money;
creating a trust;
receiving second money from investors;
funding the trust with the second money;
obligating the second party with a second obligation to give the trust a portion of the first money received from the first party; and
allowing the second party to take from the trust if the first party experiences a credit event.

20. The method as recited in claim 19, wherein the credit event includes a default on the first obligation.

21. The method as recited in claim 19, wherein the trust is controlled by a third party created by the second party.

22. The method as recited in claim 19, wherein the trust is controlled by a third party created by a fourth party.

23. The method as recited in claim 19, further comprising giving the investors notes in exchange for the second money.

24. The method as recited in claim 19, further comprising:
obligating the first party to sell underperforming assets to the second party; and
obligating the second party to give the first party value in exchange for the underperforming assets.

25. The method as recited in claim 19, wherein the funding includes purchasing a low risk asset.

26. A method for securitizing cash flow, the method comprising: securitizing the cash flow wherein the cash flow is derived from a future obligation to purchase goods or services.
